(19) United States
(12) Patent Application Publication
(10) Pub. No.: US 2002/0079796 A1
(43) Pub. Date: Jun. 27, 2002

(54) Wavelength selective optical reflector with integral light trap

(76) Inventor: Jeffrey K. Okamitsu, Westminster, MD (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/742,243

(22) Filed: Dec. 22, 2000

(51) Int. Cl. H01K 1/26; H01J 5/16; H01J 1/02

(52) U.S. Cl. 313/111; 313/25

(57) ABSTRACT

The invention is an optical device which reflects and absorbs light emitted from a light source with the reflected light being a selected wavelength range and the absorbed light being outside the selected wavelength range and a microwave excited discharge lamp. An optical device in accordance with the invention includes a light trap having a plurality of light absorbing surfaces, each light absorbing surface absorbing at least a part of incident light outside the selected wavelength range, the incident light striking an initial light absorbing area and being reflected from the initial light absorbing area to at least a secondary light absorbing area of one of the light absorbing surfaces, and a layer, fixed between the light trap and the light source, which passes the light outside the selected wavelength range to the light trap for absorption therein and which reflects the light within the selected wavelength range to a target area.

### BACKGROUND OF THE INVENTION

1. Field of the Invention

The present invention relates to optical devices which reflect and absorb light emitted from a light source with the reflected light being within a selected wavelength range and the absorbed light being outside the selective wavelength range and to discharge lamps which provide reflected light within a selected wavelength range to a target area and absorb light outside the selected wavelength range.

2. DESCRIPTION OF THE PRIOR ART

Ultraviolet (UV) light sources are used for photochemical processing and curing of coatings on substrates in a number of application fields. Typically, UV light sources also produce significant visible and infrared (IR) light with no direct use for photochemical processing and conversion. The visible and IR light undesirably heats the target area. A design constraint of UV light sources is to maximize the delivery of useful V radiation to the target area while simultaneously minimizing the delivery of visible and IR radiation to the target area.

Typical UV lamps concentrate on delivering the desired light frequencies to the illuminated target. The undesired light frequencies such as the aforementioned visible and IR portions of the light spectrum are ignored in the design.

Some UV lamps use a reflective dichroic reflector or filter to modify the light spectrum propagating toward the illuminated target area. These dichroic reflectors reflect the UV while transmitting or absorbing the visible and IR portions of the spectrum. Transmission or absorption is accomplished by using glass or metallic substrates upon which the dichroic reflector is deposited. Metallic substrates have the undesired property of interfering with the propagation of microwaves to a microwave excited light source which must be located within a microwave cavity. Glass reflectors are disadvantageous as a result of transmitting the unreflected visible and IR light to other parts of the lamp system which causes heating thereof

U.S. Pat. No. 5,039,918 discloses an electrodeless microwave lamp having a dielectric reflector which reflects a desired portion of the light spectrum to a target area and transmits the undesired portion through the reflector to other portions of the apparatus for absorption. The reflector receives the light emitted from a microwave excited light source which is comprised of a dielectric mirror which reflects the desired portion of the light spectrum to a desired target area while transmitting the undesired IR and visible portions of the light spectrum. The reflector is transparent to microwave energy. A heat absorbing coating is applied to the inner walls of the microwave cavity or to the housing, which is separated from the dielectric reflector. The dielectric reflector is formed from glass and has deposited thereon the frequency selective coating. The glass reflector has a disadvantage of being rigid in geometry and as a result lacks flexibility for alternating the imaging of reflected UV to the target area. If a change in illumination of the target area is required, it is necessary to provide a new geometry of the glass reflector. Substantial effort is required to make a new glass reflector with a different imaging geometry.

### SUMMARY OF THE INVENTION

The present invention is an optical device which reflects and absorbs light emitted from a light source with the reflected light being within a selected wavelength range and the absorbed light being outside the selected wavelength range. The optical device contains a light trap and a layer, fixed between the light trap and the light source. The light trap has a plurality of light absorbing surfaces which may be of different geometries such as without limitation planar, concave or convex surfaces as long as each light absorbing surface absorbs at least part of an incident light outside the selected wavelength range which strikes an initial light absorbing area and reflects from the initial light absorbing area non-absorbed incident light to subsequent light absorbing areas of the surfaces to substantially absorb all of the incident light. Regardless of the geometry of the light absorbing surfaces, the result of light striking at least two different surface areas, on proximal surfaces, results in effective absorption of the undesired light spectrum which in a preferred application of the invention is visible and IR components.

A layer is fixed between a light trap and a light source which passes the light outside of the selected wavelength range to the light trap for absorption therein and reflects the light within the selected wavelength range to a target area. A transparent dielectric layer is disposed between the layer and the surfaces to fill the geometry between the light reflecting surfaces and a backside of the layer. The separation provided by the transparent dielectric layer of the light trap and the frequency selective layer reduces damaging temperature gradients and thermal stress of the frequency selective layer. The frequency selective layer may be a dichroic material.

The light trap is preferably comprised of a substrate of material which absorbs heat produced from absorption of light outside the selected wavelength range. The substrate preferably has good thermal conductivity so as to conduct the absorbed heat therefrom and to facilitate removal by the blowing of air across the outside surface of the substrate from a fan such as that present in a conventional microwave excited light source for producing selected components of light such as UV. A dielectric absorber of light outside the selected range forms the light absorbing surfaces and is joined to the substrate.

The overall assembly of the light trap and the frequency selective layer is flexible. Flexibility permits deformation for focusing or directing the desired component of reflected light to a target area, which is not possible with prior art designs using glass. Furthermore, the preferred dielectric materials from which the light trap and the frequency selective layer are manufactured permits the physical size and shape thereof to be altered for different applications without requiring redesigning of the microwave cavity.

The frequency selective layer may be disposed directly on the reflective surfaces of the light trap or offset therefrom by the aforementioned transparent dielectric layer. The deposition of the frequency selective layer on the transparent dielectric layer facilitates the aforementioned flexibility.

The present invention is furthermore a microwave excited discharge lamp for providing having a microwave cavity; a light source in the cavity; a microwave generator which generates microwaves; a coupling device which couples the microwaves for the microwave generator to the microwave cavity and the aforementioned optical device.

The frequency spectrum of the light delivered to the target by reflection from the layer is dependent upon the optical passband of the layer. The reflected light may be, without limitation, UV and the transmitted light may be, without limitation, visible and IR light transmitted to the aforementioned light trap for absorption therein and conduction of heat away from the layer.

### BRIEF DESCRIPTION OF THE DRAWINGS

FIG. 1 illustrates a microwave excited discharge lamp in accordance with the invention;

FIG. 2A illustrates a first embodiment of an optical device in accordance with the invention which reflects and absorbs light such as in the microwave excited discharge lamp of FIG. 1;

FIG. 2B illustrates a second embodiment of an optical device which reflects and absorbs light such as in the microwave excited discharge lamp of FIG. 1; and

FIG. 2C illustrates a third embodiment of an optical device which reflects and absorbs light such as the microwave excited discharge lamp of FIG. 1.

Like reference numerals identify like embodiments throughout the drawings.

### DESCRIPTION OF THE PREFERRED EMBODIMENTS:

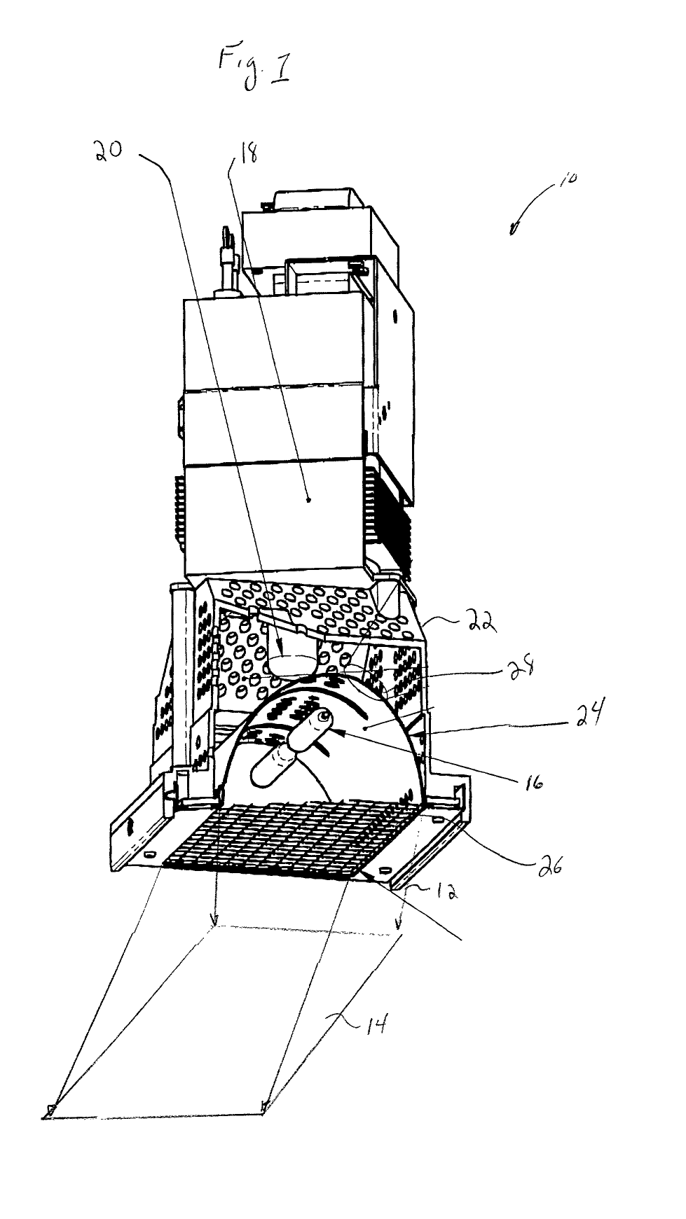

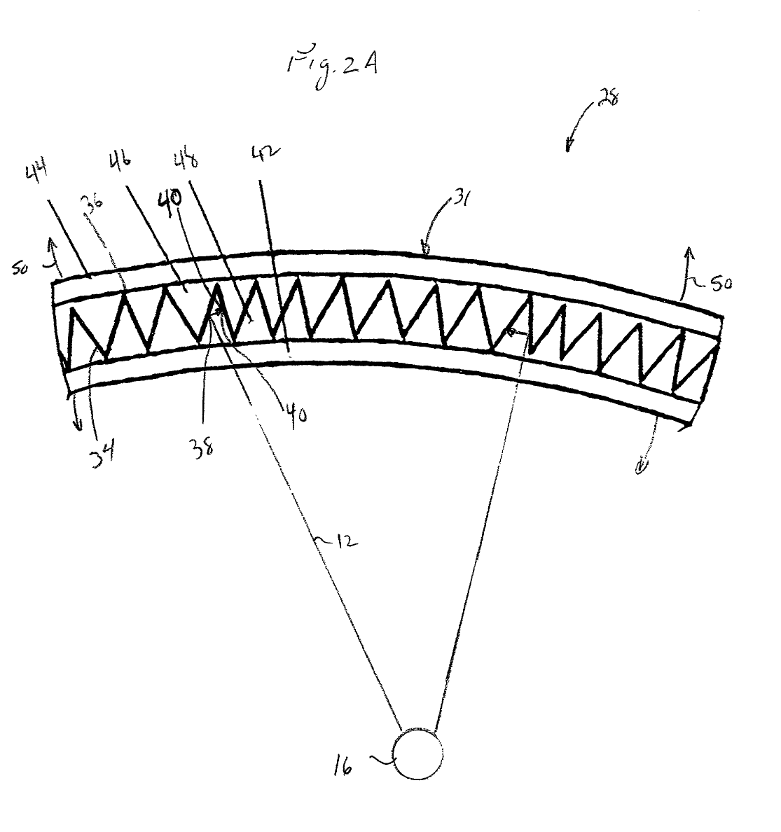

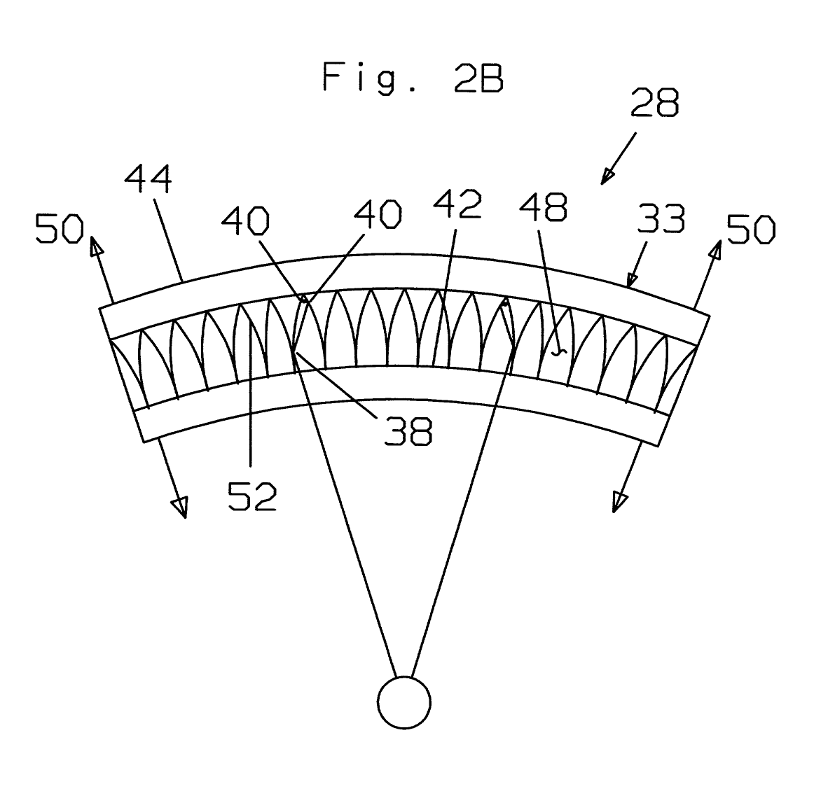

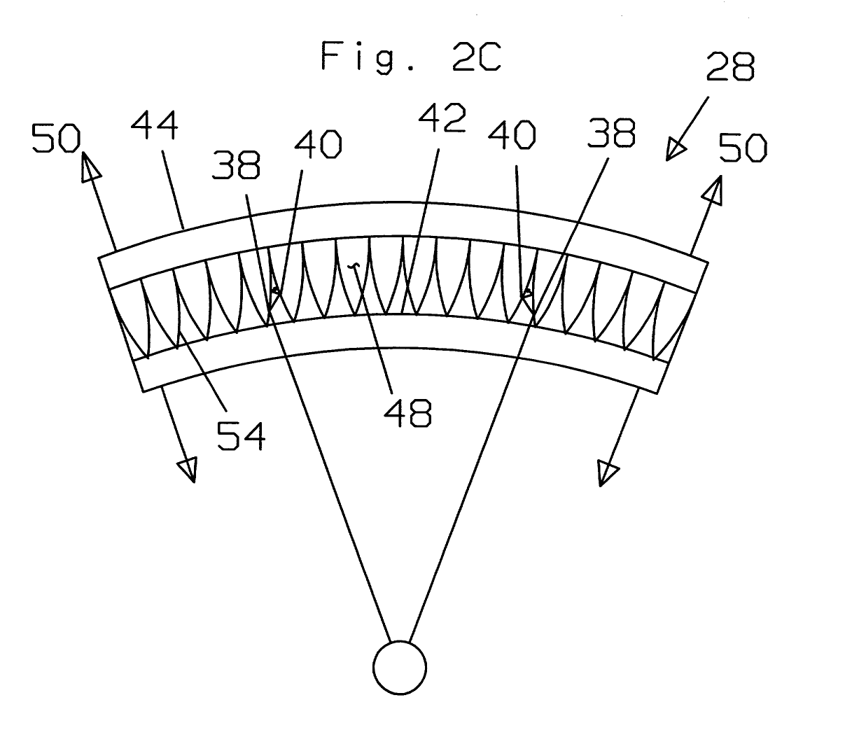

FIG. 1 illustrates an embodiment of a microwave excited discharge lamp 10 in accordance with the present invention. The discharge lamp 10 of the present invention has a preferred application of generating UV light 12 which is imaged onto a target area 14 which may be without limitation in accordance with well know applications for UV curing of coatings. Furthermore it should be understood that the present invention is not limited to the microwave generation of UV with other possible light sources other than electrodeless lamps 16 being usable to generate the light which is imaged on the target area 14. The microwave excited discharge lamp 10 includes a magneton 18 which provides the microwaves and a magnetron antenna 20 which couples microwaves generated by the magnetron into a microwave cavity 22 of conventional construction. The microwave cavity 22 includes an optical device 24 in accordance with the invention as described in more detail in the embodiments thereof in FIGS. 2A-2C.

The optical device 24, as illustrated, is semi-cylindrical in shape to reflect UV light or other selected wavelength ranges to the target area 14 and to pass light outside the selected wavelength range to a light trap described in detail in conjunction with FIGS. 2A-2C. The optical device 24 absorbs the wavelength range of light, which is desired to not be reflected to the target area 14. In a typical discharge lamp, the selected wavelength range which is reflected by the optical device 24 is in the UV range and the remaining wavelengths which are transmitted through the reflective surface thereof, as described in conjunction with FIGS. 2A-2C, without limitation are in the visible and IR ranges. Transmission of the non-UV light to surfaces for absorption removes heat locally from the top surface of the optical device which reflects only the desired selected wavelength range that is typically UV to the target 14. The generation of UV light or any other selected wavelength range with a microwave excited discharge lamp 10, such as that illustrated in FIG. 1, is conventional. The optical device 24 is made from dielectric materials which pass microwaves through the walls thereof to the electrodeless lamps 16. The dielectric materials from which the optical device 24 are manufactured are flexible which permits the configuration of the optical device to be bent to a degree which permits focusing or directing of the light emitted by the light source 16 onto the target area 14 without breakage or destruction thereof. The cavity 22 is made from electrically conductive materials which confine microwaves while at the same time permitting the UV light 12 to pass through conductive screen 26 to the target area 14.

The optical device 28 illustrated in the embodiments of FIGS. 2A-2C reflects and absorbs light emitted from the light source 16. The reflected light is within a selected wavelength range such as UV but is not limited thereto and the absorbed light is outside the selected wavelength range such as visible light and IR but is not limited thereto. FIGS. 2A-2C are cross sections of area 28 of FIG. 1. The embodiments of the light trap 31 in FIG. 2A, light trap 33 in FIG. 2B and light trap 35 in FIG. 2C function in the same manner by having a plurality of light absorbing surfaces which surfaces effectively absorb all of the light after striking initial and subsequent light absorbing areas.

The optical device 30 is comprised of a dichroic reflective coating 42, which faces the light source 16, and a substrate 44 which is located farthest from the light source 16 that is sufficiently thick to act as a heat sink. The substrate 44 is dielectric and desirably has good heat conduction properties to conduct heat thereto from an opaque dielectric absorber 46 which is disposed between the surfaces 34, 52 and 54 of the embodiments of FIGS. 2A-2C and a surface of the substrate 44 which is located closest to the light source 16. A transparent dielectric fill 48 is disposed between the dichroic reflective coating 42 and the surfaces 34, 52 and 54. The transparent dielectric fill 48 permits bending without breakage of the assembly of the optical device. The desired absorption of light is performed by scattering of the light to cause multiple incidence of light on light absorbing areas on the light absorbing surfaces 34, 52 and 54 which have a property of absorbing the light in the desired wavelength ranges such as the visible and IR ranges produced by the light source 16. Arrows 50 indicate the flexibility of the optical device 30 which can occur without breakage of the layers. This flexibility permits focusing or directing of the reflected UV light components on the target area 14. Furthermore, it is possible to have the dichroic coating 42 directly on top of the surfaces 34, 52 and 54 but such a construction is less desirable because of not providing thermal isolation between the dichroic coating 42 and the reflective surfaces 34. Without thermal isolation, localized heat could damage the dichroic coating. Any well-known dichroic material, such as, metal oxides may be used. The light reflective surfaces 34, 52, and 54 may be opaque plastic, ceramic or glass materials. The dichroic coatings 42 may be multiple layer thin film coatings which utilize interference phenomenon to selectively reflect UV light or other light ranges. A multiple layer construction permits pass band effects to be created.

In FIG. 2A, the light absorbing surfaces 34 are a series of planar surfaces that intersect at vertices or intersects 36. The light sources 16 provide light that strikes an initial light absorbing area 38 where a part of the light outside the selected wavelength range is absorbed. The remaining light, which is not absorbed by the initial light absorbing area 38, is reflected to a subsequent light absorbing area 40 where substantially all of the light which was reflected from the initial light absorbing area is absorbed. As a result of light 12 sequentially striking the initial light absorbing area 38 and the subsequent light absorbing area 40, most or all of the light energy passed by reflective layer 42 is absorbed in the light trap, which facilitates the desired separation of the desired UV component which is imaged on the target 14 from the undesired light components.

FIGS. 2B and 2C illustrate second and third embodiments 33 and 35 of an optical device in accordance with the present invention. The difference between the embodiment 31 of FIG. 2A and the embodiments 33 and 35 of FIGS. 2B and 2C is that a concave surface 52 or convex surfaces 54 are used to absorb light that strikes at least the initial light absorbing area 38 and the subsequent light absorbing areas 40. Otherwise, the second embodiment 33 and third embodiment 35 are constructed from the same materials as the first embodiment 31 and function in the same manner.

The angle between the surfaces at intersects 36 of the embodiment 31 of FIGS. 2A-2C may be varied. The surfaces 34 may form an isosceles triangle. The angles at intersects preferably ranges between 1° and 30° without being limiting of the invention thereof Furthermore, the surfaces 34 of FIG. 2A, 52 of FIG. 2B and 54 of FIG. 2C may be varied in depth. However, a depth, such as 0.1 mm, may be used. Additionally, the clear dielectric material 48, may be, without limitation, alumina.

While the optical device 28 has been illustrated as being semi-cylindrical, the shape of the cross section is not a limitation of the invention. For example, an ellipse, parabola, circle or a rectangle may be used to reflect the selected wavelength range and absorb the range outside the wavelengths that are passed.

1. An optical device which reflects and absorbs light emitted from a light source with the reflected light being within a selected wavelength range and the absorbed light being outside the selected wavelength range comprising:
a light trap having a plurality of light absorbing surfaces, each light absorbing surface absorbing at least a part of incident light outside the selected wavelength range, the incident light striking an initial light absorbing area and being partially reflected from the initial light absorbing area to at least one subsequent light absorbing area of one of the light absorbing surfaces; and
a layer, fixed between the light trap and the light source, which passes the light outside the selected wavelength range to the light trap for absorption therein and which reflects the light within the selected wavelength range to a target area.

2. An optical device in accordance with claim 1 wherein:
adjacent surfaces intersect in a series of intersects which are located at an area of the surfaces farthest from the layer, each intersect defining an angle between the surfaces which causes incident light striking one of the intersecting surfaces to strike another of the surfaces forming the intersect.

3. An optical device in accordance with claim 1 wherein:
a plurality of the surfaces are curved and concave relative to a direction of incidence of the light striking the initial light absorbing area which causes the incident light striking a concave surface to strike a different area of the concave surface.

4. An optical device in accordance with claim 1 wherein:
a plurality of the surfaces are curved and convex relative to a direction of incidence of the light striking the initial light absorbing area which causes the incident light striking one of the convex surfaces to strike another of the convex surfaces.

5. An optical device in accordance with claim 1 wherein the light trap comprises:
a substrate of a material which absorbs heat produced from absorption of the light outside the selected wavelength range; and
a dielectric absorber of the light outside the selected wavelength range which forms the light absorbing surfaces and which is joined to the substrate.

6. An optical device in accordance with claim 2 wherein the light trap comprises:
a substrate of a material which absorbs heat produced from absorption of the light outside the selected wavelength range; and
dielectric absorber of the light outside the selected wavelength range which forms the light absorbing surfaces and which is joined to the substrate.

7. An optical device in accordance with claim 3 wherein the light trap comprises:
a substrate of a material which absorbs heat produced from absorption of the light outside the selected wavelength range; and
a dielectric absorber of the light outside the selected wavelength range which forms the light absorbing surfaces and which is joined to the substrate.

8. An optical device in accordance with claim 4 wherein the light trap comprises:
a substrate of a material which absorbs heat produced from absorption of the light outside the selected wavelength range; and
a dielectric absorber of the light outside the selected wavelength range which forms the light absorbing surfaces and which is joined to the substrate.

9. An optical device in accordance with claim 1 wherein:
a transparent dielectric material is disposed between the surfaces and the layer.

10. An optical device in accordance with claim 2 wherein:
a transparent dielectric material is disposed between the surfaces and the layer.

11. An optical device in accordance with claim 3 wherein:
a transparent dielectric material is disposed between the surfaces and the layer.

12. An optical device in accordance with claim 4 wherein:
a transparent dielectric material is disposed between the surfaces and the layer.

13. An optical device in accordance with claim 5 wherein:
a transparent dielectric material is disposed between the surfaces and the layer.

14. An optical device in accordance with claim 6 wherein:
a transparent dielectric material is disposed between the surfaces and the layer.

15. An optical device in accordance with claim 7 wherein:
a transparent dielectric material is disposed between the surfaces and the layer.

16. An optical device in accordance with claim 8 wherein:
a transparent dielectric material is disposed between the surfaces and the layer.

17. An optical device in accordance with claim 1 wherein:
the layer is located directly on the surfaces.

18. An optical device in accordance with claim 2 wherein:
the layer is located directly on the surfaces.

19. An optical device in accordance with claim 3 wherein:
the layer is located directly on the surfaces.

20. An optical device in accordance with claim 4 wherein:
the layer is located directly on the surfaces.

21. An optical device in accordance with claim 5 wherein:
the layer is located directly on the surfaces.

22. An optical device in accordance with claim 6 wherein:
the layer is located directly on the surfaces.

23. An optical device in accordance with claim 7 wherein:
the layer is located directly on the surfaces.

24. An optical device in accordance with claim 8 wherein:
the layer is located directly on the surfaces.

25. An optical device in accordance with claim 9 wherein:
the transparent dielectric material is alumina.

26. An optical device in accordance with claim 9 wherein:
the transparent dielectric material is glass.

27. An optical device in accordance with claim 1 wherein the layer comprises:
a dichroic coating.

28. An optical device in accordance with claim 27 wherein:
the dichroic coating is a metal oxide.

29. An optical device in accordance with claim 1 wherein:
the light trap and layer are an assembly that is bendable sufficiently to change illumination of the target area without damage to the assembly.

30. An optical device in accordance with claim 1 wherein:
the light source produces UV, visible and IR light and the layer reflects the UV light and transmits the visible and the IR light.

31. An optical device in accordance with claim 24 wherein:
the light is an electrodeless source which is excited by microwave energy.

32. A microwave excited discharge lamp comprising:
a microwave cavity;
a light source in the cavity;
a microwave generator which generates microwaves;
a coupling device which couples the microwaves from the microwave generator into the microwave cavity; and
an optical device, disposed in the microwave cavity, which reflects and absorbs light emitted from the light source which is excited by the microwaves coupled to the cavity, the reflected light being within a selected wavelength and the absorbed light being outside the selected wavelength range, the optical device including a light trap having a plurality of light absorbing surfaces, each light absorbing surface absorbing at least a part of incident light outside the selected wavelength range, the incident light striking an initial light absorbing area and being reflected from the initial light absorbing area to at least a secondary light absorbing area of one of the light absorbing surfaces, and a layer, fixed between the light trap and the light source, which passes the light outside the selected wavelength range to the light trap for absorption therein and which reflects the light within the selected wavelength range to a target area.

33. A lamp in accordance with claim 33 wherein:
adjacent surfaces intersect in a series of intersects which are located at an area of the surface farthest from the layer, each intresect defining an angle separating the surfaces causing an incident beam striking one of the surfaces forming the intersect to strike another of the surfaces forming the intersect.

34. A lamp in accordance with claim 32 wherein:
a plurality of the surfaces are curved and concave relative to a direction of incidence of the light striking the initial light absorbing area which causes the incident light striking a concave surface to strike a different area of the concave surface.

35. A lamp in accordance with claim 32 wherein:
a plurality of the surfaces are curved and convex relative to a direction of incidence of the light striking the initial light absorbing area which causes the incident light striking one of the convex surfaces to strike another of the convex surfaces.

36. A lamp in accordance with claim 32 wherein the light trap comprises:
a substrate of a material which absorbs heat produced from absorption of the light outside the selected wavelength range; and
a dielectric absorber of the light outside the selected wavelength range which forms the light absorbing surfaces and which is joined to the substrate.

37. A lamp in accordance with claim 33 wherein the light trap comprises:
a substrate of a material which absorbs heat produced from absorption of the light outside the selected wavelength range; and
a dielectric absorber of the light outside the selected wavelength range which forms the light absorbing surfaces and which is joined to the substrate.

38. A lamp in accordance with claim 34 wherein the light trap comprises:
a substrate of a material which absorbs heat produced from absorption of the light outside the selected wavelength range; and
a dielectric absorber of the light outside the selected wavelength range which forms the light absorbing surfaces and which is joined to the substrate.

39. A lamp in accordance with claim 35 wherein the light trap comprises:
a substrate of a material which absorbs heat produced from absorption of the light outside the selected wavelength range; and
a dielectric absorber of the light outside the selected wavelength range which forms the light absorbing surfaces and which is joined to the substrate.

40. A lamp in accordance with claim 32 wherein:
a transparent dielectric material is disposed between the surfaces and the layer.

41. A lamp in accordance with claim 33 wherein:
a transparent dielectric material is disposed between the surfaces and the layer.

42. A lamp in accordance with claim 34 wherein:
a transparent dielectric material is disposed between the surfaces and the layer.

43. An optical device in accordance with claim 35 wherein:
a transparent dielectric material is disposed between the surfaces and the layer.

44. A lamp in accordance with claim 36 wherein:
a transparent dielectric material is disposed between the surfaces and the layer.

45. A lamp in accordance with claim 37 wherein:
a transparent dielectric material is disposed between the surfaces and the layer.

46. A lamp in accordance with claim 38 wherein:
a transparent dielectric material is disposed between the surfaces and the layer.

47. A lamp in accordance with claim 39 wherein:
a transparent dielectric material is disposed between the surfaces and the layer.

48. A lamp in accordance with claim 32 wherein:
the layer is located directly on the surfaces.

49. A lamp in accordance with claim 33 wherein:
the layer is located directly on the surfaces.

50. A lamp in accordance with claim 34 wherein:
the layer is located directly on the surfaces.

51. A lamp in accordance with claim 35 wherein:
the layer is located directly on the surfaces.

52. A lamp in accordance with claim 36 wherein:
the layer is located directly on the surfaces.

53. A lamp in accordance with claim 37 wherein:
the layer is located directly on the surfaces.

54. A lamp in accordance with claim 38 wherein:
the layer is located directly on the surfaces.

55. A lamp in accordance with claim 39 wherein:
the layer is located directly on the surfaces.

56. A lamp in accordance with claim 40 wherein:
the transparent dielectric material is alumina.

57. A lamp in accordance with claim 40 wherein:
the transparent dielectric material is glass.

58. A lamp in accordance with claim 32 wherein the layer comprises:
a dichroic coating.

59. A lamp in accordance with claim 58 wherein:
the dichroic coating is a metal oxide.

60. A lamp in accordance with claim 32 wherein:
the light trap and layer are an assembly which is bendable sufficiently to change illumination of the target area without breakage.

61. A lamp in accordance with claim 32 wherein:
the light source produces UV, visible and IR light and the layer reflects the UV light and transmits the visible and the IR light.
